(19) United States
(12) Patent Application Publication
(10) Pub. No.: US 2025/0174035 A1
(43) Pub. Date: May 29, 2025

(54) IMAGE PROCESSING APPARATUS, IMAGE PROCESSING METHOD, IMAGING APPARATUS, AND STORAGE MEDIUM

(71) Applicant: CANON KABUSHIKI KAISHA, Tokyo (JP)

(72) Inventor: AYANA KINOSHITA, Kanagawa (JP)

(21) Appl. No.: 18/946,585

(22) Filed: Nov. 13, 2024

(30) Foreign Application Priority Data
Nov. 29, 2023 (JP) 2023-202267

(51) Int. Cl. G06V 40/10; G06V 10/56; G06V 20/50

(52) U.S. Cl. CPC G06V 40/10; G06V 10/56; G06V 20/50

(57) ABSTRACT

An image processing apparatus includes one or more processors that, when executing a program stored in a memory, cause the image processing apparatus to detect specific subjects from an image, detect a posture of each of the detected subjects, acquire a degree of reliability of being a main subject for each of the detected subjects based on the posture, acquire information on a priority target, and determine the main subject based on the degree of reliability and the information on the priority target.

### BACKGROUND

### Field

The present disclosure relates to an image processing apparatus, an image processing method, an imaging apparatus, and a storage medium, and more particularly to a technique for determining a main subject from an image.

### Description of the Related Art

Japanese Patent Application Laid-Open No. 2021-141434 discusses a technique for estimating postures of persons in sports scenes, detecting a particular posture of interest, such as a shot or a goal, and determining the main subject.

When the main subject is determined as discussed in Japanese Patent Application Laid-Open No. 2021-141434, if a subject not targeted by the user takes the particular posture, the subject may be wrongly determined as the main subject.

### SUMMARY OF THE INVENTION

The present disclosure has been made in consideration of the above situation, and is directed to a technique for determining a desired main subject even in a case where a plurality of subjects is present.

According to an aspect of the present disclosure, an image processing apparatus includes one or more processors that, when executing a program stored in a memory, cause the image processing apparatus to detect specific subjects from an image, detect a posture of each of the detected subjects acquire a degree of reliability of being a main subject for each of the detected subjects based on the posture, acquire information on a priority target, and determine the main subject based on the degree of reliability and the information on the priority target.

Further features of the present disclosure will become apparent from the following description of exemplary embodiments with reference to the attached drawings.

### BRIEF DESCRIPTION OF THE DRAWINGS

FIG. 1 is a block diagram illustrating a configuration of an imaging apparatus as an example of an image processing apparatus according to an exemplary embodiment.

FIG. 2 is a block diagram illustrating a part of a detailed configuration of an image processing unit according to the exemplary embodiment.

FIG. 3 is a flowchart of main subject determination processing according to the exemplary embodiment.

FIG. 4 is a block diagram illustrating apart of a detailed configuration of a subject information detection unit according to the exemplary embodiment.

FIG. 5 is a flowchart of subject information detection processing according to the exemplary embodiment.

FIGS. 6A and 6B are diagrams illustrating examples of subjects and goal positions in a soccer game and a basketball game according to the exemplary embodiment.

FIGS. 7A and 7B are diagrams illustrating examples of posture information by which the main subject determination unit according to the exemplary embodiment determines a main subject.

FIGS. 8A and 8B are diagrams of information acquired by a posture acquisition unit and an object detection unit according to the exemplary embodiment.

FIG. 9 is a diagram illustrating an example of a structure of a neural network according to the exemplary embodiment.

### DESCRIPTION OF THE EMBODIMENTS

The present disclosure will be described below in detail based on an exemplary embodiment thereof with reference to the accompanying drawings.

### Overall Configuration

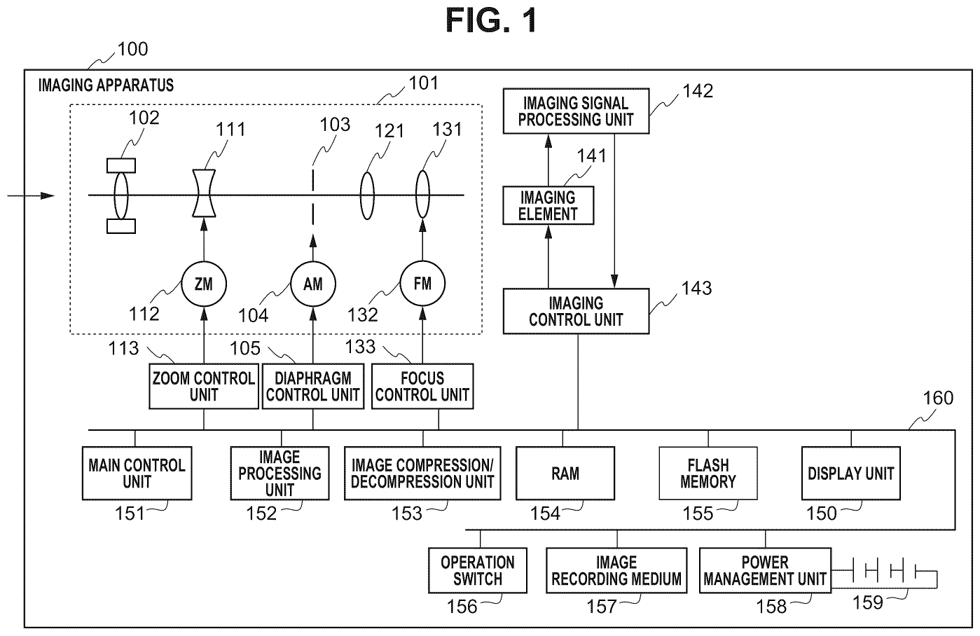

FIG. 1 is a block diagram illustrating a configuration of an imaging apparatus 100 that includes a main subject determination device as an example of an image processing apparatus according to an exemplary embodiment. The imaging apparatus 100 is a digital still camera or video camera that captures an image of a subject and records moving image data or still image data on various media, such as a tape, a solid-state memory, an optical disk, or a magnetic disk, but the imaging apparatus 100 is not limited thereto. A case where the subject is a person is described below as an example. A main subject refers to a subject that is a target of imaging control intended by a user. Each unit in the imaging apparatus 100 is connected via a bus 160. Each unit is controlled by a main control unit 151.

A lens unit 101 includes a fixed first group lens 102, a zoom lens 111, a diaphragm 103, a fixed third group lens 121, and a focus lens 131. A diaphragm control unit 105 drives the diaphragm 103 via an aperture motor (AM) 104 in response to a command from the main control unit 151, thereby adjusting the aperture diameter of the diaphragm 103 and regulating the amount of light during imaging. A zoom control unit 113 drives the zoom lens 111 via a zoom motor (ZM) 112 to change the focal length. A focus control unit 133 determines the drive amount of driving a focus motor (FM) 132 based on the amount of shift of the lens unit 101 in a focusing direction. The focus control unit 133 drives the focus lens 131 via the focus motor (FM) 132 to control a focus adjustment state. Autofocus (AF) control is achieved through a movement control of the focus lens 131 by the focus control unit 133 and the FM 132. The focus lens 131 is a lens for focus adjustment. While FIG. 1 illustrates the focus lens 131 as a single lens, the focus lens 131 can include a plurality of lenses.

An image of the subject formed on an imaging element 141 through the lens unit 101 is converted into an electrical signal by the imaging element 141. The imaging element 141 is a photoelectric conversion element that photoelectrically converts the image of the subject (optical image) into an electrical signal. The imaging element 141 includes “m” pixels arranged in a horizontal direction and “n” pixels arranged in a vertical direction as light receiving elements. The image formed on and photoelectrically converted by the imaging element 141 is adjusted as an image signal (image data) by an imaging signal processing unit 142. This enables obtaining an image on an imaging plane.

The image data output from the imaging signal processing unit 142 is sent to an imaging control unit 143 and temporarily accumulated in a random access memory (RAM) 154. The image data accumulated in the RAM 154 is compressed by an image compression/decompression unit 153, and then recorded on an image recording medium 157. In parallel, the image data accumulated in the RAM 154 is sent to an image processing unit 152.

The image processing unit 152 performs predetermined image processing on the image data accumulated in the RAM 154. The image processing performed by the image processing unit 152 includes, but is not limited to, development processing such as white balance adjustment, color interpolation (demosaic), gamma correction, signal format conversion processing, and scaling processing. The image processing unit 152 also determines the main subject based on information on posture of each subject (for example, joint positions) and positional information on an object unique to a scene (hereinafter, referred to as a unique object). The image processing unit 152 can use a result of determination processing in other image processing (for example, the white balance adjustment). The image processing unit 152 saves the processed image data, the information on the posture of each subject, the positional information and information on size of the unique object, positional information about the barycenter, face, and pupils of the main subject, and the like in the RAM 154.

An operation switch 156 is an input interface including a touch panel, buttons, and the like, and enables the user to perform various operations on the imaging apparatus 100 by selecting various functional icons displayed on a display unit 150.

The main control unit 151 includes one or more programmable processors, such as a central processing unit (CPU) and a micro processing unit (MPU). The main control unit 151 controls each unit of the imaging apparatus 100 by reading a program stored in a flash memory 155 into the RAM 154 and executing the program, for example, thereby implementing functions of the imaging apparatus 100. The main control unit 151 also executes auto exposure (AE) processing to automatically determine exposure conditions (shutter speed or accumulation time, aperture value, and sensitivity) based on subject luminance information. The subject luminance information can, for example, be obtained from the image processing unit 152. The main control unit 151 can also determine the exposure conditions based on an area of a specific subject, such as a person's face.

The focus control unit 133 performs AF control on a position of the main subject saved in the RAM 154. The diaphragm control unit 105 performs exposure control using a luminance value of a specific subject area.

The display unit 150 displays an image, a detection result of a main subject, and the like. A battery 159 is managed by a power management unit 158 and provides a stable power supply to the entire imaging apparatus 100.

The flash memory 155 records a control program necessary for operation of the imaging apparatus 100, parameters used for operation of each unit, and the like. When the imaging apparatus 100 is started up by a user operation (when the imaging apparatus 100 shifts from a power-off state to a power-on state), the control program and the parameters stored in the flash memory 155 are read into a part of the RAM 154. The main control unit 151 controls the operation of the imaging apparatus 100 based on the control program and constants loaded into the RAM 154.

### Main Subject Determination Processing

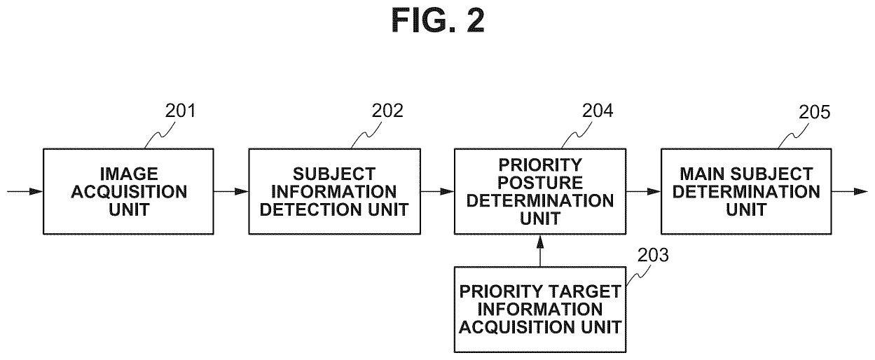

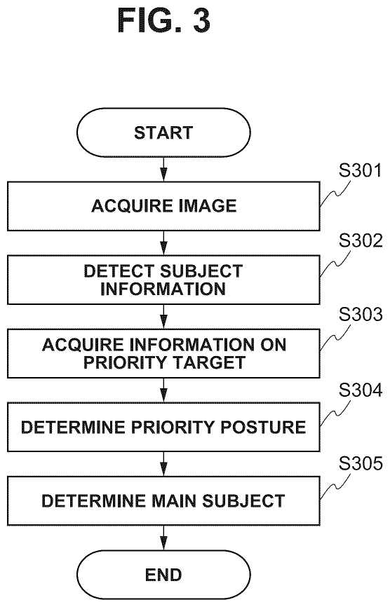

Main subject determination processing executed by the image processing unit 152 will be described with reference to FIGS. 2 and 3. FIG. 2 is a block diagram illustrating a part of a detailed configuration of the image processing unit 152. FIG. 3 is a flowchart of the main subject determination processing. Unless otherwise specified, each step in the flowchart is implemented by each part of the image processing unit 152 operating under the control of the main control unit 151. In the following description, a scene of a ball game played by a plurality of persons is assumed as a captured scene that is a target of the main subject determination processing. However, the captured scene to which the present exemplary embodiment can be applied is not limited thereto.

In step S301, an image acquisition unit 201 acquires an image captured at a time of interest from the imaging control unit 143. In step S302, a subject information detection unit 202 detects a unique object (a predetermined type of object) and subjects (persons) from the image acquired by the image acquisition unit 201. The subject information detection unit 202 then obtains information on the posture of each subject, and calculates a degree of reliability that indicates likelihood of a subject being the main subject in subject information from the information on the object and the information on the posture of the subject.

In step S303, a priority target information acquisition unit 203 acquires information on a priority target registered by the user. The information on the priority target is information required for the user to determine a target that the user wishes to prioritize as the main subject in capturing an image, such as the position of a goal, the position of a court, or a color of a uniform of a team to be imaged. In the main subject determination processing, to determine which subject is to be the main subject from among a plurality of subjects detected by the subject information detection unit 202, it is necessary to determine the main subject using the information on the priority target. The information on the priority target is saved in advance in the flash memory 155 and is stored in the RAM 154 as necessary.

In step S304, a priority posture determination unit 204 determines a priority posture using the information on the subjects detected by the subject information detection unit 202 and the information on the priority target acquired by the priority target information acquisition unit 203. There are two methods for determining the priority posture: determining based on which posture is taken by the team to be imaged and/or determining based on whether the detected posture is the posture taken by the team to be imaged. Either or both of these methods can be used.

First, the method for determining the priority posture based on which posture is taken by the team to be imaged will be described. The priority posture determination unit 204 selects a specific posture using, for example, the goal position or court position acquired by the priority target information acquisition unit 203. For example, in a case where detected postures can be classified into an offensive posture and a defensive posture, if the team to be imaged is on an offensive side of a playing area, the offensive posture is selected as the priority posture. If the team to be imaged is on a defensive side of a playing area, the defensive posture is selected as the priority posture. Examples of the offensive posture include a shot, a spike, and the like. Examples of the defensive posture include sliding, blocking, and the like. To determine whether the team to be imaged is on the offensive side or the defensive side, the method for determining the priority posture is changed depending on a game to be imaged.

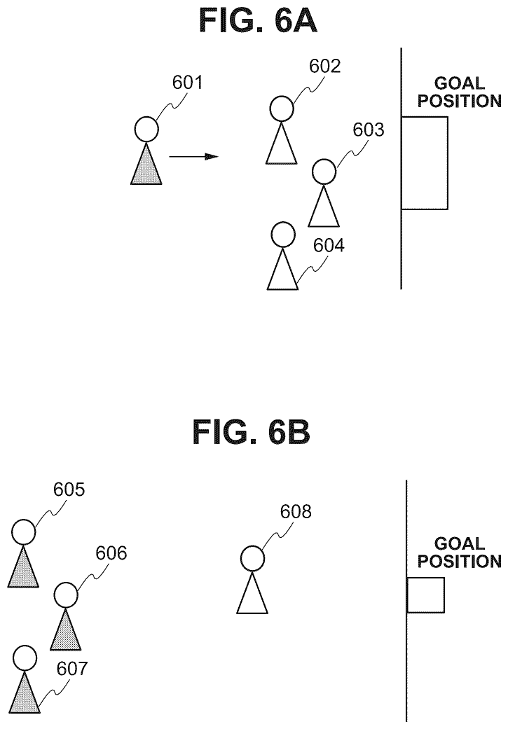

FIGS. 6A and 6B illustrate examples of subjects and goal positions in a soccer game and a basketball game. FIG. 6A illustrates an example of the subjects and the goal position in the soccer game. If a subject 601 moves significantly toward the registered goal position as illustrated in FIG. 6A, it can be determined that the subjects of the team to be imaged are on the offensive side. Thus, setting the offensive posture as the priority posture enables prioritizing the posture information on the subject 601, which is a subject of the team to be imaged. If the position of the registered goal is in the same direction as a panning direction of the imaging apparatus 100, the offensive posture is set as the priority posture.

FIG. 6B illustrates an example of the subjects and the goal positions in the basketball game. If the subjects are gathered in a direction opposite to the registered basket position as in FIG. 6B, it can be determined that players of the team to be imaged are on defense. Thus, setting the defensive posture as the priority posture enables prioritizing the posture information on subjects 605, 606, and 607, which are subjects of the team to be imaged. In a volleyball game, for example, if a ball is in a registered court position, it can be determined that the team to be imaged is on the offensive side, so the offensive posture is set as the priority posture.

Next, the method for determining whether the detected posture is the posture taken by the team to be imaged will be described. The priority posture determination unit 204 compares the color of the uniform worn by a person in the detected posture with the color of the uniform acquired and registered by the priority target information acquisition unit 203. A comparison method using template matching or histogram matching can be used based on a feature amount of an area of the uniform. If it is determined that the registered color of the uniform and the color of the uniform worn by the person in the detected posture are the same, the detected posture is assumed to be the posture taken by the subject of the team to be imaged. Accordingly, the detected posture is determined as the priority posture. If there is a plurality of detected postures, the color of the uniform in each posture is compared with the registered color of the uniform to determine the priority posture. There can be one or more priority postures.

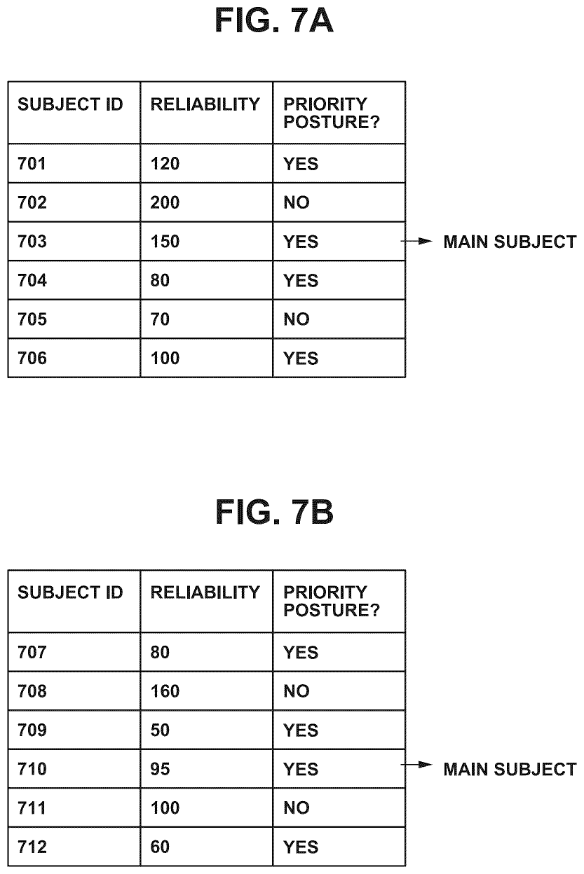

Returning to FIG. 3, in step S305, a main subject determination unit 205 determines a subject with the highest degree of reliability as the main subject from among the subjects in the priority posture determined by the priority posture determination unit 204. FIGS. 7A and 7B illustrate examples of subject information used by the main subject determination unit 205 to determine the main subject. A subject identification (ID) is assigned to each detected subject, and each subject is associated with the degree of reliability and information on whether the subject is in a priority posture. When there is a plurality of pieces of subject information as in FIG. 7A, a subject 703 with the highest degree of reliability from among the subjects in the priority posture is determined as the main subject.

To make it easier for a subject in a priority posture to be determined as the main subject, a threshold of the degree of reliability can be set low for only the priority posture. For example, if the priority posture is the offensive posture, the threshold of the degree of reliability can be set low for only the offensive posture. For example, in FIG. 7B, when the threshold of the degree of reliability for the priority posture is set to 90 and the threshold of the degree of reliability for postures other than the priority posture is set to 100, a subject 710 with the highest degree of reliability from among the subjects in the priority posture is determined as the main subject. The main subject determination unit 205 then stores coordinates of joints of the main subject and representative coordinates indicating the main subject (such as a barycentric position or a face position) in the RAM 154. The main subject determination processing then ends.

### Subject Information Detection Processing

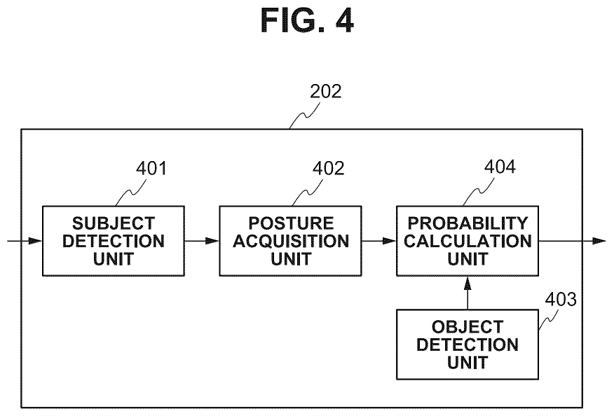

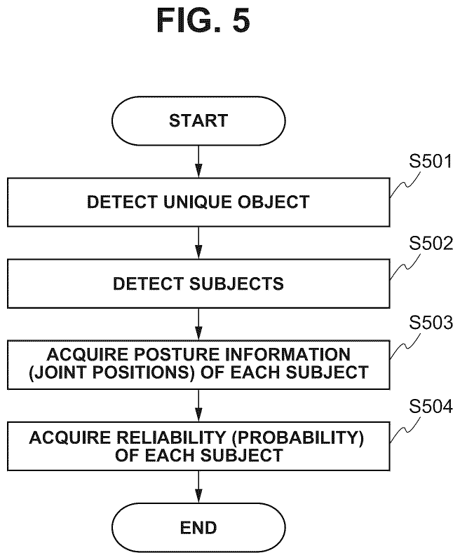

FIG. 4 is a block diagram illustrating a part of a detailed configuration of the subject information detection unit 202. FIG. 5 is a flowchart of subject information detection processing in step S302.

In step S501, an object detection unit 403 detects a unique object (a predetermined type of object) in the image acquired by the image acquisition unit 201, and acquires two-dimensional coordinates and a size of the unique object in the image. The type of unique object to be detected is determined based on the captured scene of the image. In this case, since the captured scene is a scene of a ball game, the object detection unit 403 detects a ball as the unique object. However, depending on the captured scene, any object moving between players in sports, such as a puck in ice hockey, a shuttlecock in badminton, etc., other than a ball can be detected.

In step S502, a subject detection unit 401 detects subjects (persons) in the image acquired by the image acquisition unit 201.

In step S503, a posture acquisition unit 402 performs posture estimation on each of the plurality of subjects detected by the subject detection unit 401 to acquire the posture information. Details of the posture information to be acquired are determined based on a type of subject. In this case, since the subjects are persons, the posture acquisition unit 402 acquires positions of joints of the persons as the subjects as the posture information.

The method for estimating the posture of the subject from an image of the subject area can be any known method. For example, the method described in Cao, Zhe, et al., “Realtime multi-person 2d pose estimation using part affinity fields”, Proceedings of the IEEE Conference on Computer Vision and Pattern Recognition, 2017 can be used.

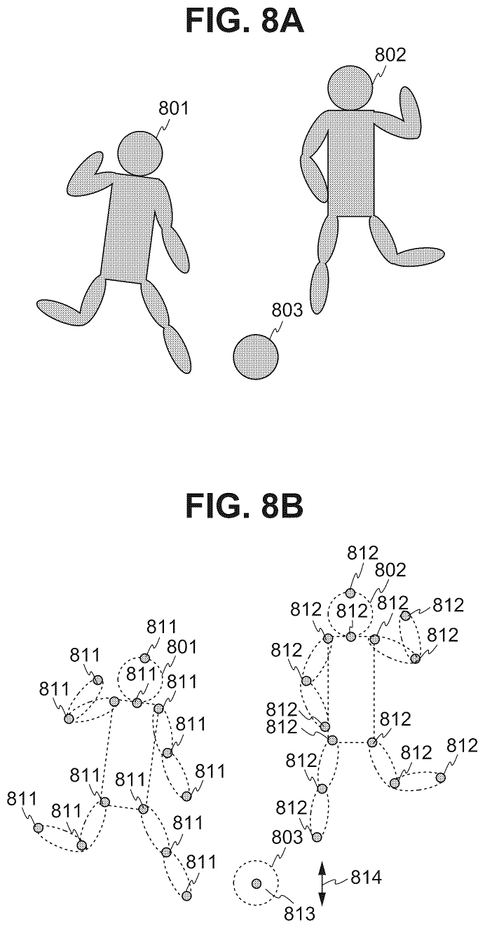

FIGS. 8A and 8B are diagrams of information acquired by the posture acquisition unit 402 and the object detection unit 403. FIG. 8A illustrates an image to be processed, where a subject 801 is in a posture of being about to kick a ball 803. The subject 801 is an important subject in a captured scene. In the present exemplary embodiment, the posture information of subjects and the information on a unique object are used to determine the main subject that is likely to be intended by the user as a target for imaging control. A subject 802 is a non-main subject. The non-main subject herein refers to a subject other than the main subject.

FIG. 8B is a diagram illustrating an example of the posture information of the subjects 801 and 802, and the position and size of the ball 803. More specifically, FIG. 8B illustrates an example in which the positions of the top of the head, neck, shoulders, elbows, wrists, waist, knees, and ankles are acquired as joint positions. The joint positions can be some of these or other positions can be acquired. Joints 811 represent joints of the subject 801 and joints 812 represent joints of the subject 802. In addition to the joint positions, information on axes connecting the joints can be used, and any information that represents the posture of the subject can be used as the posture information. In the following case, the joint positions are acquired as the posture information.

The posture acquisition unit 402 acquires two-dimensional coordinates (x, y) of the joints 811 and 812 in the image. Herein, the unit of the two-dimensional coordinates (x, y) is pixels. A barycentric position 813 represents the barycentric position of the ball 803, and arrows 814 represent the size of the ball 803 in the image. The object detection unit 403 acquires the two-dimensional coordinates (x, y) of the barycentric position 813 of the ball 803 in the image, and the number of pixels indicating the width of the ball 803 in the image.

The description will now return to FIG. 5. In step S504, a probability calculation unit 404 calculates a degree of reliability (probability) that represents the likelihood of each subject being the main subject based on at least one of the coordinates of the joints estimated by the posture acquisition unit 402 or the coordinates and size of the unique object acquired by the object detection unit 403. A method for calculating the probability will be described below. In the present exemplary embodiment, the probability of each subject being the main subject in the processing target image is used as the degree of reliability representing the likelihood of each subject being the main subject (degree of reliability corresponding to a degree of possibility that each subject is the main subject in the processing target image). Alternatively, a value other than the probability can be used. For example, the reciprocal of a distance between the barycentric position of the subject and the barycentric position of the unique object can be used as the degree of reliability.

### Method for Calculating Probability

A method for calculating the probability of each subject being the main subject, performed by the probability calculation unit 404, based on the coordinates of each joint and the coordinates and size of a unique object will be described. A case where a neural network, which is a technique of machine learning, is used will be described below.

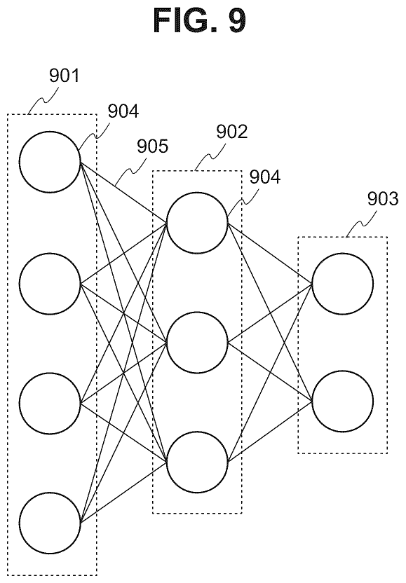

FIG. 9 is a diagram illustrating an example of a structure of a neural network. The neural network includes an input layer 901, an intermediate layer 902, and an output layer 903. There can be a plurality of intermediate layers 902. Each layer includes a plurality of neurons 904, where the neurons 904 in adjacent layers are connected to each other by a synapse 905.

The number of the neurons 904 in the input layer 901 is equal to a dimension of input data. The number of the neurons 904 in the output layer 903 is equal to the number of answers. In this case, the output layer 903 includes two neurons 904 because the neural network is used to obtain two answers, i.e., whether a certain type of subject is the main subject or not. The neural network that classifies inputs into two classes is used to determine whether a first type of subject is the main subject or not (whether the probability is high or low).

A weight of the synapse 905 connecting the i-th neuron 904 in the input layer 901 and the j-th neuron 904 in the intermediate layer 902 is defined as Wᵢⱼ. In this case, an output zⱼ of the j-th neuron 904 in the intermediate layer 902 is provided by the following formulas:

$${z}_{j} = h ( {b}_{j} + {\sum }_{i} {w}_{ji} {x}_{i} ) \qquad ( 1 )$$

$$h ( z ) = max ( z , 0 ) \qquad ( 2 )$$

In Formula (1), xᵢ represents a value input to the i-th neuron 904 in the input layer 901.

Since all neurons 904 in the input layer 901 are connected to the j-th neuron 904 in the intermediate layer 902, each input value of the neuron 904 in the input layer 901 is weighted, summed, and input to the j-th neuron 904 in the intermediate layer 902.

The j-th neuron 904 in the intermediate layer 902 outputs a value of an activating function h whose argument is a value obtained by adding a bias bⱼ to the input value. The bias bⱼ is a parameter corresponding to sensitivity of the neuron 904. The activating function h is a function that converts an input value into a value that represents an excited state of a neuron.

In this case, Rectified Linear Unit (ReLU) is used, but another function, such as a sigmoid function, can be used.

The weight of the synapse 905 connecting the j-th neuron 904 in the intermediate layer 902 and the k-th neuron 904 in the output layer 903 is defined as wₖⱼ, and the bias of the k-th neuron 904 in the output layer 903 is defined as bk. In this case, a value yₖ output by the k-th neuron 904 in the output layer 903 is provided by the following formulas:

$${y}_{k} = f ( {b}_{k} + {\sum }_{j} {w}_{kj} {z}_{j} ) \qquad ( 3 )$$

$$( {y}_{k} ) = \frac{exp ( {y}_{k} )}{{\sum }_{i} exp ( {y}_{i} )} \qquad ( 4 )$$

In Formula (3), zⱼ is an output value from the j-th neuron 904 in the intermediate layer 902, connected to the k-th neuron 904 in the output layer 903. In addition, i and k are numbers for the neurons 904 in the output layer 903, where i, k=1 or 2. The value yₖ output by each neuron 904 in the output layer 903 is normalized by a softmax function in Formula (4) such that the sum becomes 1. Where y₁ corresponds to the classification of the main subject and y₂ corresponds to the classification of the non-main subject, f(y₁) represents a probability of each subject being the main subject, and f(y₂) represents a probability of each subject being a non-main subject.

The input values to the neural network are the coordinates of joints of a person and the coordinates and size of a ball. All the weights and biases are optimized by learning to minimize a loss function that uses the output probability and a correct-answer label. The correct-answer label is a binary value of 1 for the main subject and 0 for a non-main subject. The loss function can be any function that can measure a degree of agreement with the correct-answer label, such as a mean squared error. As an example, binary cross-entropy described below is used here as the loss function:

$$L ( y , t ) = - {\sum }_{m} {t}_{m} log {y}_{m} - {\sum }_{m} ( 1 - {t}_{m} ) log ( 1 - {y}_{m} ) \qquad ( 5 )$$

In Formula (5), m is the index of the subject to be learned, yₘ is equal to a probability value f(y₁) output from the neuron 904 with k=1 in the output layer 903, and tₘ is the correct-answer label (0 or 1).

Optimizing the value of Formula (5) to be small enables the weights and biases to be learned such that the correct-answer label and the output probability value are closer to each other.

The learned weights and biases are saved in advance in the flash memory 155, and are stored in RAM 154 as necessary. Pluralities of types of weights and biases can be prepared depending on the scene. The probability calculation unit 404 uses the learned weights and biases (results of machine learning performed in advance) to output the probability value f(y₁) based on Formulas (1) to (4).

At the time of learning of the neural network, the subject information (here, the joint positions) on a subject in a state immediately before moving to an important action can be used as information on a state of the main subject. For example, in the case of sports involving throwing of a ball, the joint positions detected from an image of the subject whose hand is stretched forward to throw a ball can be used as one state of the main subject in learning. A reason for such learning is to enable the imaging apparatus 100 to execute appropriate control on a subject having taken an action for which the subject is to be determined as the main subject. For example, when the degree of reliability (probability value) corresponding to the main subject exceeds a preset threshold, the control of automatically recording an image or a video (recording control) is started so that the user can capture an important moment without missing the moment. At this time, the imaging apparatus 100 can perform the control using information on a typical time to the important action from the state to be learned.

The method for calculating the probability using a neural network has been described. Other machine learning techniques, such as a support vector machine and a decision tree, can be used as long as it is possible to classify subjects into the main subject and the non-main subjects. Instead of using the machine learning, a function that outputs a degree of reliability or a probability value based on a certain model can be constructed. As described above with reference to FIG. 5, it is also possible to use a value of a monotonically decreasing function of the distance between a subject and an unique object, assuming that the degree of reliability of the subject being the main subject increases as the distance between the subject and the unique object decreases.

In the description with reference to FIG. 5, the main subject is determined using the posture information on the subject and the information on the unique object. The main subject can also be determined using only the posture information on the subject. In addition, the main subject can be determined using, as input data, data obtained by subjecting the positions of the joints and the position and size of the unique object to a predetermined transformation, such as a linear transformation.

As described above, in the present exemplary embodiment, the imaging apparatus 100 detects a plurality of postures from the processing target image. Then, the imaging apparatus 100 acquires the information on the priority target and determines a posture to be prioritized from among the plurality of postures based on the information on the priority target. This enables determining the main subject close to the user's intention in the image in which a plurality of subjects is present.

In the above-described exemplary embodiment, the configuration is described in which it is determined whether the detected posture is the posture taken by the subject of the team to be imaged. The present disclosure can also be applied to a configuration in which a posture to be prioritized is determined at the time of searching through captured images for an image in which the subject is in a desired posture. The present invention can also be applied to a configuration in which a posture to be detected with priority is determined at the time of editing images.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-202267, filed Nov. 29, 2023, which is hereby incorporated by reference herein in its entirety.

What is claimed is:

1. An image processing apparatus comprising:
one or more processors that, when executing a program stored in a memory, cause the image processing apparatus to:
detect specific subjects from an image;
detect a posture of each of the detected subjects;
acquire a degree of reliability of being a main subject for each of the detected subjects based on the posture;
acquire information on a priority target; and
determine the main subject based on the degree of reliability and the information on the priority target.

2. The image processing apparatus according to claim 1, wherein the image processing apparatus further selects a specific posture from among a plurality of detected postures as a priority posture and determines the main subject based on the priority posture.

3. The image processing apparatus according to claim 2, wherein the image processing apparatus further determines whether the priority target is on an offensive side or a defensive side of a playing area and selects either an offensive posture or a defensive posture as the priority posture.

4. The image processing apparatus according to claim 2, wherein the image processing apparatus further determines whether each of the plurality of detected postures is a posture of the priority target and sets the posture of the priority target as the priority posture.

5. The image processing apparatus according to claim 2, wherein the image processing apparatus changes processing of determining the priority posture depending on a sport.

6. The image processing apparatus according to claim 2, wherein the image processing apparatus further sets a threshold of a degree of reliability for detecting a posture depending on the priority posture.

7. The image processing apparatus according to claim 1, wherein the detected plurality of postures includes an offensive posture and a defensive posture.

8. The image processing apparatus according to claim 4, wherein the image processing apparatus further determines whether each of the plurality of detected postures is the posture of the priority target based on a color of a uniform.

9. The image processing apparatus according to claim 1, wherein the image processing apparatus registers at least one of a goal position, a court position, or a color of a uniform as the information on the priority target.

10. The image processing apparatus according to claim 5, wherein the image processing apparatus determines the priority posture based on at least one of prioritizing an offensive posture when a goal position on a playing area is present in a panning direction of the image processing apparatus, prioritizing the offensive posture when there is a subject moving toward the goal position, prioritizing a defensive posture when there are subjects gathered in a direction opposite to the goal position, prioritizing the offensive posture when there is a ball in a court position of a playing area, or prioritizing the posture of a subject wearing a uniform of a registered color.

11. The image processing apparatus according to claim 6, wherein, when the priority posture is an offensive posture, the image processing apparatus sets the threshold of the degree of reliability for the offensive posture to a lower value than the threshold of the degree of reliability for a defensive posture.

12. An imaging apparatus comprising:
an imaging unit configured to capture an image; and
an image processing apparatus comprising:
one or more processors that, when executing a program stored in a memory, cause the image processing apparatus to:
detect specific subjects from an image;
detect a posture of each of the detected subjects;
acquire a degree of reliability of being a main subject for each of the detected subjects based on the posture;
acquire information on a priority target; and
determine the main subject based on the degree of reliability and the information on the priority target,
wherein the image processing apparatus detects the specific subjects using the image captured by the imaging unit.

13. An image processing method comprising:
detecting specific subjects from an image;
detecting a posture of each of the detected subjects;
acquiring a degree of reliability of being a main subject for each of the detected subjects based on the posture;
acquiring information on a priority target; and
determining the main subject based on the degree of reliability and the information on the priority target.

14. A non-transitory computer-readable storage medium storing a program for causing a computer to execute an image processing method, the method comprising:
detecting specific subjects from an image;
detecting a posture of each of the detected subjects;
acquiring a degree of reliability of being a main subject for each of the detected subjects based on the posture;
acquiring information on a priority target; and
determining the main subject based on the degree of reliability and the information on the priority target.
